(19) United States
(12) Patent Application Publication
(10) Pub. No.: US 2026/0359684 A1
(43) Pub. Date: Nov. 12, 2026

(54) COUNTERFACTUAL-BASED ORCHESTRATION FOR ANNEALERS FOR HIGH PRIORITY QUBO PROBLEMS

(71) Applicant: Dell Products L.P., Round Rock, TX (US)

(72) Inventors: Ítalo Gomes Santana, Rio de Janeiro (BR); Miguel Paredes Quiñones, Campinas (BR); Diego Vrague Noble, Pelotas (BR)

(21) Appl. No.: 18/605,721

(22) Filed: Mar. 14, 2024

(51) Int. Cl. G06N 7/00

(52) U.S. Cl. CPC G06N 7/00

(57) ABSTRACT

One example method includes, based on a data structure C received from a user, generating a list CF of counterfactual quadratic unconstrained binary optimization (QUBO) instances Q′ according to C, and the QUBO instances Q′ are based on an original QUBO Q, for each Q′ in CF, building a ranking r′ of solvers according to all predictions from service level objectives SLOᵢ for Q′, and then storing {Q′, r′}, computing a respective ranking score for each pair {Q′, r′}, selecting whichever pair {Q′, r′} has a highest-ranking score {Q_{b}, r_{b}}, and sending Q_{b} to a head of ranking r₁_{_{b}}.

### FIELD OF THE INVENTION

Embodiments of the present invention generally relate to the solution of QUBO (quadratic unconstrained binary optimization) problems. More particularly, at least some embodiments of the invention relate to systems, hardware, software, computer-readable media, and methods, for counterfactual-based selection of an annealer for the solution of a QUBO.

### BACKGROUND

There are often circumstances in which a QUBO may be solved by a variety of different annealers. Thus, a decision is needed to identify which particular annealer will be selected for solution of a QUBO. One approach is to rank the annealers according to various criteria. However, ranking lists generated by orchestrators of annealers have temporal validity. That is, the ranking information may become increasingly outdated as time advances due to various circumstances, such the best suited annealer is offline, or network issues that prevent the selection of a preferred annealer. However, using an outdated or invalid ranking list is not optimal when dealing with high priority optimization workloads as the annealer chosen from an outdated list may result not only in a failure to honor SLAs (service level agreements) but also poor resource utilization.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a relation between optimization problems and corresponding physical systems.

FIG. 2 discloses aspects of an example of a quantum annealing workflow.

FIG. 3 discloses an illustration of the embedding problem.

FIG. 4 discloses a comparison of simulated annealing and quantum annealing.

FIG. 5 discloses an example method, and some associated architectural elements, according to an embodiment.

FIG. 6 discloses aspects of an example embodiment of a computing entity, which may comprise classical and/or quantum components, including annealers, configured and operable to perform part, or all, of any of the disclosed methods, processes, and operations.

### DETAILED DESCRIPTION OF SOME EXAMPLE EMBODIMENTS

Embodiments of the present invention generally relate to the solution of QUBO (quadratic unconstrained binary optimization) problems. More particularly, at least some embodiments of the invention relate to systems, hardware, software, computer-readable media, and methods, for counterfactual-based selection of an annealer for the solution of a QUBO.

One example embodiment is directed to a method for implementing counterfactual-based orchestration for annealers used to solve high priority QUBO problems. One example of such a method comprises the operations: generating a list of counterfactual QUBO instances CF according to C; for each Q′ in CF, building a ranking r′ of annealers according to all predictions from SLOᵢ for Q′, and then storing {Q′, r′}; computing the ranking score of each pair {Q′, r′} generated earlier—in an embodiment, this ranking score takes the current Quantum Annealing (QA) orchestration infrastructure state to produce the scores; selecting the pair with the highest score {Q_{b}, r_{b}}; and sending Q_{b} to the head of ranking r_{b}, that is, r₁_{_{b}}. Then, the annealer with the ranking r₁_{_{b}} may be used to solve Q_{b}.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in anyway. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an orchestrator may dynamically adapt to changing conditions in the state of annealers that may be potential options for solving a QUBO. An embodiment may generate and maintain updated information that may be used to select an annealer for a QUBO. An embodiment may provide a mechanism to rank QUBOs for solution. An embodiment may modify QUBOs to change their waiting time in an orchestration system. Various other advantages of one or more example embodiments will be apparent from this disclosure.

### A. Context for an Example Embodiment

The following is a discussion of aspects of an example context for various embodiments of the invention. This discussion is not intended to limit the scope of the invention, or the applicability of the embodiments, in any way.

### A.1 QUBO Optimization Problems

A QUBO is a type of combinatorial optimization problem that enables many real-world problems to be encoded in the following format:

$$H ( x ) = {\sum }_{i < j} {q}_{i , j} {x}_{i} {x}_{j} + {\sum }_{i} {q}_{i} {x}_{i}^{2} = {x}^{T} Q x$$

Where x∈{0,1}ⁿ.

### A.2 Quantum Annealing

Quantum Annealing (QA) tries to interpolate between a static problem-independent Hamiltonian for which the ground state can be efficiently prepared, and a final Hamiltonian whose ground state yields the desired answer. The QA system then linearly interpolates between H₀ and H_{f} (H_{f}=Q).

H(t)=α(t)H₀+β(t)H_{f}

Where: H_{f} is the Hamiltonian of the problem to be solved.

This system represented by H(t) evolves following the time-dependent Schrodinger equation. The system is manipulated in the manner of creating a quantum tunneling effect that makes that the system converge closer to the ground state.

### A.3 Quantum Annealing Intuition

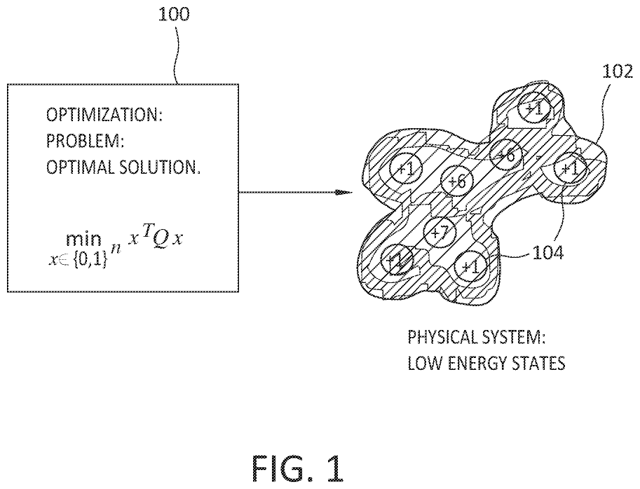

With reference briefly to FIG. 1, a solution to an optimization problem 100, such as a QUBO for example, may be thought of as being analogous to, or equating in some way to, a physical system 102. More specifically, the physical system 102 may have a variety of different low energy states 104, which may be referred to as local minima, each of which may comprise or corresponds to a respective solution to the optimization problem 100. The lowest energy state 104 may correspond to the optimal solution to the optimization problem 100.

### A.4 Example Quantum Annealing Workflow

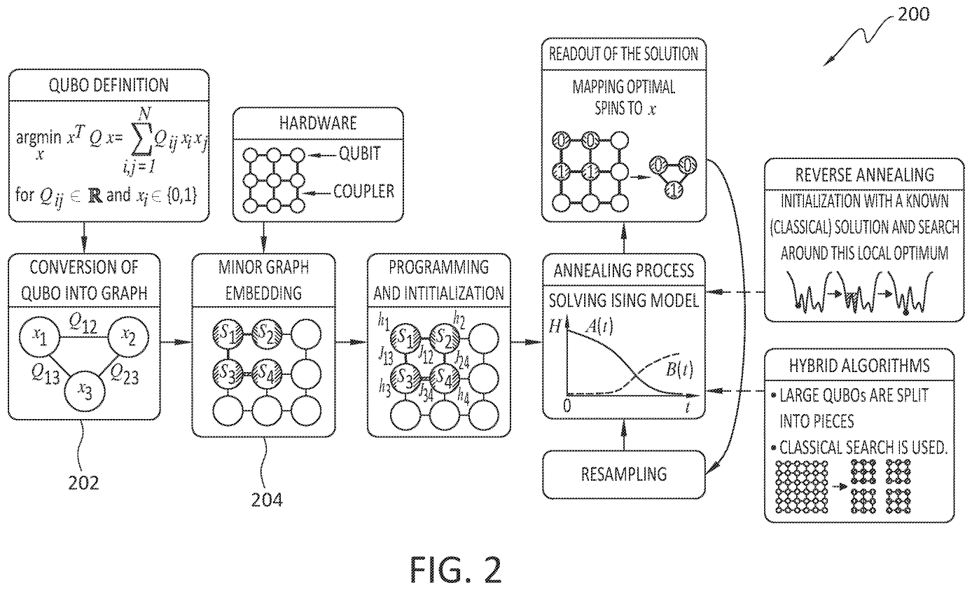

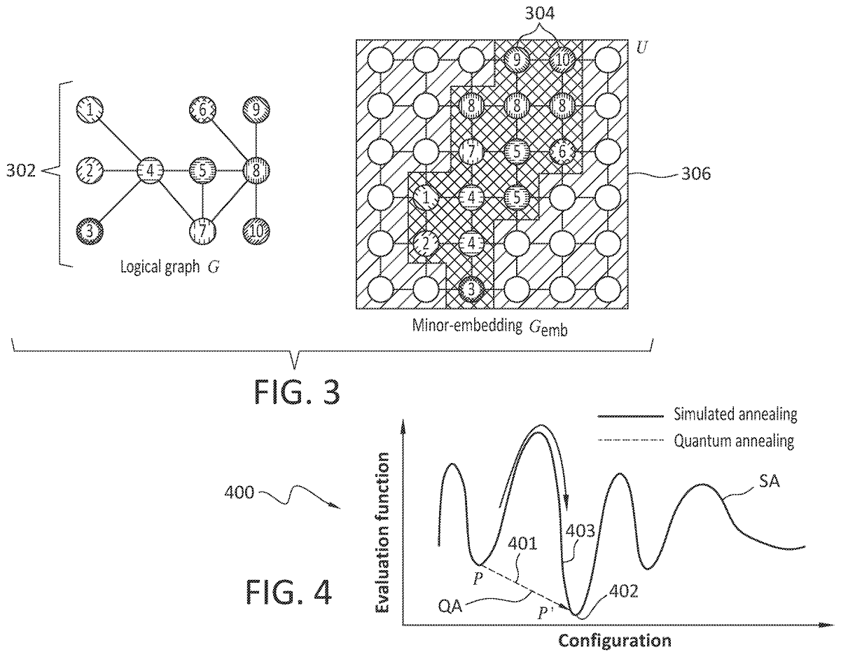

FIG. 2 discloses an example quantum annealing workflow 200. A conversion 202 of a QUBO into a graph may necessitate a graph embedding process 204 which may implicate a minor embedding problem, as disclosed in the example of FIG. 3.

### A.5 the Minor Embedding Problem

With reference now to FIG. 3, in order to solve combinatorial optimization problems such as QUBOs, it is necessary to map graph nodes 302, such as may be obtained at 202 in the example of FIG. 2, to the qubits 304 implemented in the hardware 306. In practice, heuristics may be used for this mapping. However, weak embeddings can drastically reduce the number of qubits in the hardware that are available for computation, which in turn may prevent the resolution of larger problem instances.

### A.6 Other Annealers

Simulated quantum annealing (SQA) refers to computational techniques used to simulate the physics of QA. SQA may be performed using classical computing, see, for example, https://tutorial.openjij.org/build/html/en/001-Introduction.html (OpenJiJ), classical accelerators as in the NEC vector annealing approach, or by creating specialized hardware to simulate the behavior of QA, as in the case of the Fujitsu hardware.

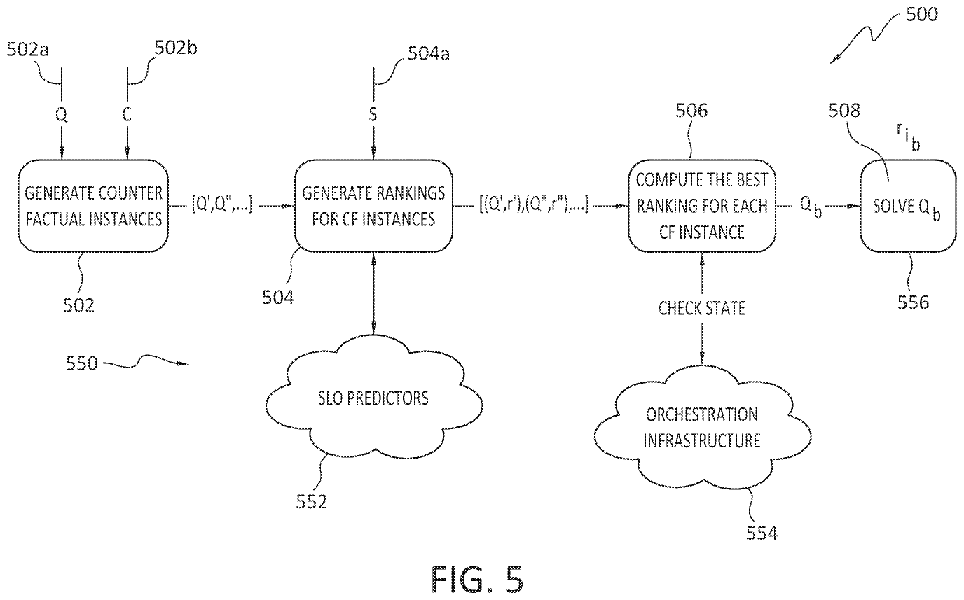

Simulated Annealing (SA) is a metaheuristic that resembles the annealing process on metallurgy where a QUBO can be encoded on the process of controlled cooling of a metal. SA can provide good solutions for a large range of problems but there is strong evidence that QA can find the global minimum, that is, solutions, of some problems exponentially more quickly than SA. For example, in the graph 400 in FIG. 4, it can be seen that the QA process reaches the global minimum 402 much more quickly than does the SA approach 403 because QA can leverage quantum effects such as tunneling during the search.

### B. Context for an Example Embodiment

Counterfactual explanations are a type of explanation that explores “what-if” scenarios to understand the causes and consequences of a particular event or outcome. The term “counterfactual” refers to something that is contrary to the facts or the actual reality.

In the context of machine learning (ML), counterfactual explanations may be used to explain predictions or decisions made by ML models. They provide insights into why a model made a specific prediction by considering alternative scenarios or changes to the input data that is provided to the ML model. In the case of quantum annealing orchestration, if ML models are used to decide the best annealer to run a QUBO problem, then the application of counterfactual explanations allows for the explication of such decisions as to which annealer was selected.

When explaining a prediction, counterfactual-based methods attempt to identify the minimal changes required in the input variables, or features, to alter the decision, or target variable, generated by the model. Such methods may generate a set of “counterfactual instances” that represent alternative scenarios where the model would have made a different prediction. These instances are often generated by modifying the input features to the model, while keeping other factors constant.

Consider, for example, an optimization problem sought to be solved by an orchestration system which computes a ranking of annealers in order of suitability based on some criteria, such as, for example, compliance with Service Level Agreements (SLAs), or cost or time constraints. In this hypothetical example, counterfactual explanations may provide expeditious backup alternatives to this ranking in case of a mishap or problem with the original ranking, for example, the best candidate annealer is unexpectedly down, and so a new candidate must be urgently selected, by modifying the original structure of the problem to run high priority optimization problems. Those high priority problems must be previously known by the user so that they can be modified by the orchestrator to fit with an annealer.

### C. Aspects of an Example Embodiment

### C.1 Introduction

An example embodiment comprises a method based on counterfactual explanations that receives an original QUBO and outputs rankings for each new counterfactual QUBO in a way that an annealer orchestrator could exploit each according to its current infrastructure state. The method may comprise changing the input data, which may be QUBO or Ising models, in multiple ways so that alternatives and more robust rankings are generated. These rankings may be at hand whenever the infrastructure being orchestrated changes.

In an embodiment, various assumptions may be employed. Thus, one example embodiment may assume the following:
Valid and small QUBO modifications are valid at the cost of obtaining a lower quality solution whenever there is a high priority execution of a given QUBO;
There is an orchestrator O that, for an input QUBO job Q, decides the best annealer solver of a set of solvers S, where examples of such solvers include, but are not limited to, a simulated quantum annealer, quantum annealer, simulated annealer;
For each sᵢ∈S, there exists a trained ML model SLOᵢ that predicts a set of SLO (service level objective) metrics sloᵢ when solving Q—one or more example ML models for SLO metrics are disclosed in U.S. patent application Ser. No. 18/321,207, which is incorporated herein in its entirety by this reference, and constituted example embodiments of SLOᵢ;
There exists a data structure C, which may be received from a user, that contains information about soft constraints at the original QUBO—this data structure contains information considering which constraints, that is, the soft constraints, can be changed or neglected in case that the original QUBO cannot be executed as it is originally intended to be;
The modifications applied to the input data, whether that input is a QUBO or Ising model, may be minimal in the sense that the original input problem is kept but features of the original input problem that can be neglected, that is, the soft constraints, are removed or modified;
A ranking r is a permutation on S, that is, let S={s₁, s₂, . . . , sₙ}, r is a n-tuple (sᵢ_{₁}, sᵢ_{₂}, . . . , sᵢ_{ₙ}) where iⱼ∈{1, 2, . . . , n} for all 1≤j≤n, and iⱼ≠iₖ for all j≠k; and
The QA orchestration infrastructure is represented by the state of all solvers in S. For instance, not all solvers may be online, and some solvers may have a busier job queue while other solvers are idle.

### C.2. Aspects of an Example Method According to One Embodiment

It is noted with respect to the disclosed methods, including the example method of FIG. 5, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

In an embodiment, part or all of the method 500 may be performed by an architecture 550 that comprises one or more SLO predictors 552, an orchestration infrastructure 554, and one or more solvers 556, such as annealers. However, this architecture 550 is provided only by way of example and is not intended to limit the scope of the invention in any way.

Directing attention now to FIG. 5, the example method 500 may begin with generation 502 of a list CF of counterfactual QUBO instances Q′ according to the data structure C 502b. The QUBO Q 502a and the data structure C 502b may be inputs, possibly from a user, to the generation 502 process.

Next, for each Q′ in CF: building 504 a ranking r′ of annealers, indicated as a set of solvers 504a S in FIG. 5, according to all predictions generated by the SLO predictors 552 from SLOᵢ for Q′; and, storing {Q′, r′}. When this has been done, respective ranking scores may be computed 506 for each pair {Q′, r′} generated at 504. These ranking scores may take the current QA orchestration infrastructure state, which may be provided by the orchestration infrastructure 554, to produce the ranking scores.

The pair {Q′, r′} with the highest-ranking score may then be selected, and the corresponding Q_{b} sent to the head of ranking r_{b}, that is, r₁_{_{b}}. The Q_{b} may then be solved 508 by one of the solvers 556.

### C.3 Some Example Variations

With regard to the example method 500, a number of variations may be implemented. Some examples of these are presented below.

Turning first to the generation 502 of counterfactual instances, an embodiment may modify features x of Q in a manner that the changes are kept at a minimum by doing the following:
(a) performing a reduction of density using a ranking obtained from a heatmap that indicates which coefficients of the original Q can be neglected. In an embodiment, a heatmap corresponds to a numerical matrix output by a surrogate ML model trained on historical data of similar problems, where each matrix cell indicates the probability of the pair (i,j) to be used in the current problem. Thus, each pair (i,j) stands for a qubit pair in a QUBO or Ising model. In one embodiment, the generation of such matrix may be performed by the application of a graph neural network, using Q as test data, as disclosed in “Kool, Wouter, Herke van Hoof, and Max Welling. “Attention, Learn to Solve Routing Problems!.” (in International Conference on Learning Representations. 2018), which is incorporated herein in its entirety by this reference; and
(b) then, a straightforward approach may be used to remove qubit pairs of Q whose probabilities are below a pre-defined threshold in the heatmap and are only related with soft constraints. As a result, this approach keeps the same problem setting but reduces the density of the problem while preserving the material elements of the problem. Another approach considers using a rank list of soft constraints coming from the user to recompile the problem, where this action can guide the density decrease more specifically since some restrictions, such as hard constraints, are more important than others, such as soft constraints, and their terms corresponding to the penalization of the constraints can be neglected without material impact on the outcome.

With regard to the computing 504 of the ranking scores, at least two alternatives are possible. These are discussed in turn below.

One such alternative is rank aggregation. In light of the fact that 504 may produce multiple ranking lists, an embodiment may merge those ranking lists into a single final ranking list using any rank aggregation algorithm. A ranking aggregation algorithm can aggregate the preferences, that is, the rankings, of multiple agents, that is, inputs, into a list while maximizing the number of pairwise agreements between the final ranking and the existing rankings, such as by using the Kemeny rule. Although this is a NP-hard problem, there are numerous efficient heuristics that tackle this problem. The final ranking is a heuristic solution that represents the better “consensus” among all other rankings. It is this consensus that makes the new ranking more robust. In this embodiment, the infrastructure state is disregarded.

Another alternative relating to 504 concerns infrastructure aware orchestration. That is, this alternative embodiment considers the current state of each solver s E S with regards to their job queue load, SLO compliance, QUBO transmission, computational resources available, and possibly other factors as well. For each solver, assess its score. After that, it is necessary to give a score for each ranking generated. An aggregated score can consider, for instance, a summation of the solver score multiplied by n−i, where i is the place of the solver in the ranking. In this way, high ranked solvers will receive higher scores.

### D. Further Discussion

As will be apparent from this disclosure, one or more example embodiments may possess various useful features and aspects, although no embodiment is required to possess any particular features or aspects. The following examples are illustrative.

An embodiment may comprise a method that generates slightly different QUBOs to accelerate their waiting time, that is, reduce their waiting time, in a QA orchestration system. An embodiment may comprise an approach that ranks high priority QUBOs which are not required to be solved exactly as they arrive on the orchestrator queue. An embodiment may comprise a method that leverages multiple SLO predictors to improve the execution of jobs in a QA orchestrator. An embodiment may comprise a method, based on counterfactual explanations, to generate new QUBOs that can be ranked and solved by the best solver of a QA an orchestration system.

### E. Further Example Embodiments

Following are some further example embodiments of the invention. These are presented only by way of example and are not intended to limit the scope of the invention in any way.

Embodiment 1. A method, comprising: based on a data structure C received from a user, generating a list CF of counterfactual quadratic unconstrained binary optimization (QUBO) instances Q′ according to C, and the QUBO instances Q′ are based on an original QUBO Q; for each Q′ in CF, building a ranking r′ of solvers according to all predictions from service level objectives SLOᵢ for Q′, and then storing {Q′, r′}; computing a respective ranking score for each pair {Q′, r′}; selecting whichever pair {Q′, r′} has a highest-ranking score {Q_{b}, r_{b}}; and sending Q_{b} to a head of ranking r₁_{_{b}}.

Embodiment 2. The method as recited in any preceding embodiment, wherein the ranking scores are based on a current QA orchestration infrastructure state.

Embodiment 3. The method as recited in any preceding embodiment, wherein features of the original QUBO Q that can be ignored are either modified, or removed.

Embodiment 4. The method as recited in any preceding embodiment, wherein the respective rankings r′ of one or more of the solvers is/are recomputed when a change occurs that affects availability of one of the solvers to solve an instance of Q′.

Embodiment 5. The method as recited in any preceding embodiment, wherein one or more of the solvers comprises a respective annealer.

Embodiment 6. The method as recited in any preceding embodiment, wherein a validity of the ranking r′ of solvers is maintained over time notwithstanding changes affecting availability of one or more of the solvers.

Embodiment 7. The method as recited in any preceding embodiment, wherein the solver with the ranking r₁_{_{b}} is used to solve Q_{b}.

Embodiment 8. The method as recited in any preceding embodiment, wherein one or more of the counterfactual quadratic unconstrained binary optimization (QUBO) instances Q′ are created by performing a density reduction on the original QUBO Q, and then removing, from the original QUBO Q, qubit pairs whose probabilities are below a pre-defined threshold in a heatmap that indicates which coefficients can be neglected or removed from the original QUBO Q.

Embodiment 9. The method as recited in any preceding embodiment, wherein the rankings r′ of the solvers are merged together into a single final ranking list using a rank aggregation algorithm.

Embodiment 10. The method as recited in any preceding embodiment, wherein information about respective states of each of the solvers is used to rank, and score, the solvers.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

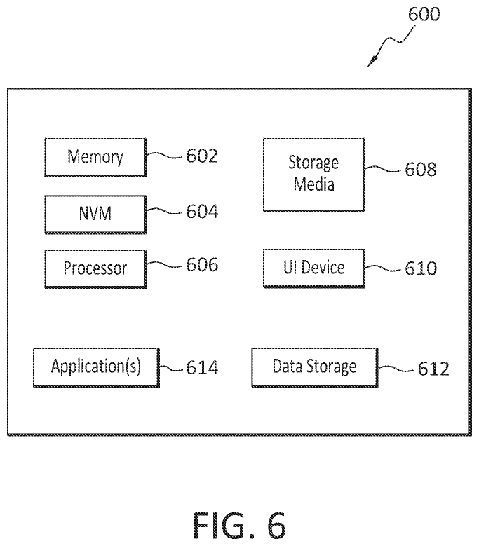

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

An embodiment of the computing device 600, or another computing device, may comprise quantum hardware, classical computing hardware, or a combination of quantum and classical computing hardware. By way of example, one embodiment may employ an annealer which may comprise, or consist of, classical computing components such as memory and processors for example. One embodiment may employ an annealer that comprises, or consists, of a quantum annealer. An annealer according to one embodiment may be a digital annealer, or a simulated annealer. No particular type or configuration of annealer is required in any embodiment however. In one embodiment, an explainer may comprise, or consist of, classical computing components.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
based on a data structure C received from a user, generating a list CF of counterfactual quadratic unconstrained binary optimization (QUBO) instances Q′ according to C, and the QUBO instances Q′ are based on an original QUBO Q;
for each Q′ in CF, building a ranking r′ of solvers according to all predictions from service level objectives SLOᵢ for Q′, and then storing {Q′, r′};
computing a respective ranking score for each pair {Q′, r′};
selecting whichever pair {Q′, r′} has a highest-ranking score {Q_{b}, r_{b}}; and
sending Q_{b} to a head of ranking r₁_{_{b}}.

2. The method as recited in claim 1, wherein the ranking scores are based on a current QA orchestration infrastructure state.

3. The method as recited in claim 1, wherein features of the original QUBO Q that can be ignored are either modified, or removed.

4. The method as recited in claim 1, wherein the respective rankings r′ of one or more of the solvers is/are recomputed when a change occurs that affects availability of one of the solvers to solve an instance of Q′.

5. The method as recited in claim 1, wherein one or more of the solvers comprises a respective annealer.

6. The method as recited in claim 1, wherein a validity of the ranking r′ of solvers is maintained over time notwithstanding changes affecting availability of one or more of the solvers.

7. The method as recited in claim 1, wherein the solver with the ranking r₁_{_{b}} is used to solve Q_{b}.

8. The method as recited in claim 1, wherein one or more of the counterfactual quadratic unconstrained binary optimization (QUBO) instances Q′ are created by performing a density reduction on the original QUBO Q, and then removing, from the original QUBO Q, qubit pairs whose probabilities are below a pre-defined threshold in a heatmap that indicates which coefficients can be neglected or removed from the original QUBO Q.

9. The method as recited in claim 1, wherein the rankings r′ of the solvers are merged together into a single final ranking list using a rank aggregation algorithm.

10. The method as recited in claim 1, wherein information about respective states of each of the solvers is used to rank, and score, the solvers.

11. A non-transitory storage medium having stored therein instructions that are executable by one or more hardware processors to perform operations comprising:
based on a data structure C received from a user, generating a list CF of counterfactual quadratic unconstrained binary optimization (QUBO) instances Q′ according to C, and the QUBO instances Q′ are based on an original QUBO Q;
for each Q′ in CF, building a ranking r′ of solvers according to all predictions from service level objectives SLOᵢ for Q′, and then storing {Q′, r′};
computing a respective ranking score for each pair {Q′, r′};
selecting whichever pair {Q′, r′} has a highest-ranking score {Q_{b}, r_{b}}; and
sending Q_{b} to a head of ranking r₁_{_{b}}.

12. The non-transitory storage medium as recited in claim 11, wherein the ranking scores are based on a current QA orchestration infrastructure state.

13. The non-transitory storage medium as recited in claim 11, wherein features of the original QUBO Q that can be ignored are either modified, or removed.

14. The non-transitory storage medium as recited in claim 11, wherein the respective rankings r′ of one or more of the solvers is/are recomputed when a change occurs that affects availability of one of the solvers to solve an instance of Q′.

15. The non-transitory storage medium as recited in claim 11, wherein one or more of the solvers comprises a respective annealer.

16. The non-transitory storage medium as recited in claim 11, wherein a validity of the ranking r′ of solvers is maintained over time notwithstanding changes affecting availability of one or more of the solvers.

17. The non-transitory storage medium as recited in claim 11, wherein the solver with the ranking r₁_{_{b}} is used to solve Q_{b}.

18. The non-transitory storage medium as recited in claim 11, wherein one or more of the counterfactual quadratic unconstrained binary optimization (QUBO) instances Q′ are created by performing a density reduction on the original QUBO Q, and then removing, from the original QUBO Q, qubit pairs whose probabilities are below a pre-defined threshold in a heatmap that indicates which coefficients can be neglected or removed from the original QUBO Q.

19. The non-transitory storage medium as recited in claim 11, wherein the rankings r′ of the solvers are merged together into a single final ranking list using a rank aggregation algorithm.

20. The non-transitory storage medium as recited in claim 11, wherein information about respective states of each of the solvers is used to rank, and score, the solvers.
